(19) United States
(12) Patent Application Publication
(10) Pub. No.: US 2014/0067879 A1
(43) Pub. Date: Mar. 6, 2014

(54) APPLICATION MANAGEMENT FOR A TERMINAL

(71) Applicant: PANTECH CO., LTD., Seoul (KR)

(72) Inventors: Hyoung-Sik AHN, Seongnam-si (KR); Tae-Heon Hong, Seoul (KR)

(73) Assignee: Pantech Co., Ltd., Seoul (KR)

(21) Appl. No.: 13/863,694

(22) Filed: Apr. 16, 2013

(30) Foreign Application Priority Data
Aug. 29, 2012 (KR) 10-2012-0095205

(51) Int. Cl. G06F 17/30

(52) U.S. Cl. CPC G06F 17/30312
USPC 707/812

(57) ABSTRACT

A method and terminal for managing additional file associated with an application are provided. The terminal includes: an application controller configured to install, execute and uninstall an application on the computer; a non-system area configured to store an additional file associated with the application; and an additional file manager configured to manage an additional file database that stores the association of the application to the additional file, wherein the application controller communicates with the additional file manager when the non-system area is accessed.

### CROSS-REFERENCE TO RELATED APPLICATION

This application claims the priority of and benefit under 35 U.S.C. §119 of Korean Patent Application No. 10-2012-0095205, filed on Aug. 29, 2012, the entire disclosure of which is incorporated herein by reference for all purposes.

### BACKGROUND

1. Field

The following description relates to an apparatus and method for application management when an application is installed, executed, and uninstalled.

2. Discussion of the Related Art

A mobile device, such as, a smart phone or a tablet computer, as well as a desktop computer or a laptop computer has an operating system (OS). The OS is installed in the device to control the device, and instruct and control the executions of application programs. The OS can be classified as either a conventional OS or a mobile OS. The conventional OS can be used for a desktop computer, a laptop computer, etc. A mobile OS can be used for a mobile device, such as, a smart phone, a tablet computer. ANDROID, IOS, and WINDOWS MOBILE have been widely used as a mobile OS.

A variety of applications for using a device are installed on an OS. Some applications are installed by the device manufacturer, some by a communications company before the device is released, and some by an end user who can install desired applications. The user can update the installed applications or uninstall unnecessary applications.

Applications or application programs are usually installed in a system area of the internal memory of the device, together with OS software. All or a part of files or data required for execution of applications and/or generated during execution of applications are stored in the system area. However, since the capacity of the system area is limited, an OS may limit files and/or data that are stored in the system area. Some files or data required for applications or generated by applications may be stored in a non-system area of the memory. The user may arbitrarily move files and/or data stored in the system area to a non-system area. Generally, when a user installs or executes an application, the user may not know the kinds, number, capacities, etc. of the additional files of the application and may not know if the additional files of the application are stored in a non-system area.

If the user uninstalls the installed application, files stored in a system area allocated for the application are deleted. However, generally, files or data (hereinafter, referred to as “additional application files”) stored in a non-system area are not deleted even when the user uninstalls the installed application. Unnecessary files remain in the non-system area making efficient management of the storage difficult. Unnecessary additional application files may leave insufficient space in the storage.

A method in which a user drives a separate application (for example, an application program such as a file manager for file deletion) to find remaining application files and delete them can be considered. However, it is very inconvenient for a user to find additional application files and delete them. It is not easy to find all of the additional application files as it may not be easy to recognize the names, number, stored locations, etc. of additional application files related to an application.

### SUMMARY

The following description relates to a device capable of efficiently managing additional application files when an application is installed, updated, executed, or uninstalled in the device, and an application management method of the device.

The following description also relates to a device capable of preventing unnecessary additional application files from remaining in the memory of a device, and an application management method of the device.

The following description also relates to a device allowing a user to delete unnecessary additional application files when uninstalling an application, and an application management method of the device.

According to exemplary embodiments, there is provided a terminal for managing applications on a computer, the terminal including: an application controller configured to install, execute and uninstall an application on the computer; a non-system area configured to store an additional file associated with the application; and an additional file manager configured to manage an additional file database that stores the association of the application to the additional file, wherein the application controller communicates with the additional file manager when the non-system area is accessed.

According to exemplary embodiments, there is provided a method for managing applications on a computer, the method including: installing, executing and uninstalling an application on the computer; providing a non-system area for storing an additional file associated with the application; and managing an additional file database that stores the association of the application to the additional file, based on a communication indicating an access to the non-system area.

According to exemplary embodiments, there is provided a non-transitory computer-readable storage media having stored thereon a computer program that, when executed by a terminal including a display and one or more processors, causes the one or more processors to perform operations to manage applications of the terminal, the operations including: installing, executing and uninstalling an application on the computer; providing a non-system area for storing an additional file associated with the application; and managing an additional file database that stores the association of the application to the additional file, based on a communication indicating an access to the non-system area.

Additional features of the invention will be set forth in the description that follows, and in part will be apparent from the description, or may be learned by practice of the invention.

It is to be understood that both the foregoing general description and the following detailed description are exemplary and explanatory and are intended to provide further explanation of the invention as claimed. Other features and aspects will be apparent from the following detailed description, the drawings, and the claims.

### BRIEF DESCRIPTION OF THE DRAWINGS

The accompanying drawings, which are included to provide a further understanding of the invention and are incorporated in and constitute a part of this specification, illustrate exemplary embodiments of the invention, and together with the description serve to explain the principles of the invention.

FIG. 1 illustrates a device including an application management function according to exemplary embodiments.

FIG. 2 illustrates an additional file DB configured in the form of a table according to exemplary embodiments.

FIG. 3A illustrates an additional file DB including an application table according to exemplary embodiments.

FIG. 3B illustrates an additional file DB including an additional file table according to exemplary embodiments.

FIG. 3C illustrates an additional file DB including an application management table according to exemplary embodiments.

FIG. 4 illustrates an application management method according to exemplary embodiments.

FIG. 5 illustrates an application management method according to exemplary embodiments.

FIG. 6 illustrates an application management method according to exemplary embodiments.

FIG. 7A illustrates a screen displayed on a touch screen when a process of deleting additional files proceeds according to exemplary embodiments.

FIG. 7B illustrates a screen displayed on a touch screen when a process of deleting additional files proceeds according to exemplary embodiments.

FIG. 7C illustrates a screen displayed on a touch screen when a process of deleting additional files proceeds according to exemplary embodiments.

### DETAILED DESCRIPTION

The following description is provided to assist the reader in gaining a comprehensive understanding of the methods, apparatuses, and/or systems described herein. Accordingly, various changes, modifications, and equivalents of the methods, apparatuses, and/or systems described herein will suggest themselves to those of ordinary skill in the art. Also, descriptions of well-known functions and constructions may be omitted for increased clarity and conciseness.

The invention is described more fully hereinafter with reference to the accompanying drawings, in which exemplary embodiments of the invention are shown. This invention may, however, be embodied in many different forms and should not be construed as limited to the embodiments set forth herein. Rather, these exemplary embodiments are provided so that this disclosure is thorough, and will fully convey the scope of the invention to those skilled in the art. It will be understood that for the purposes of this disclosure, “at least one of X, Y, and Z” can be construed as X only, Y only, Z only, or any combination of two or more items X, Y, and Z (e.g., XYZ, XZ, XYY, YZ, ZZ). Throughout the drawings and the detailed description, unless otherwise described, the same drawing reference numerals are understood to refer to the same elements, features, and structures. The relative size and depiction of these elements may be exaggerated for clarity.

The terminology used herein is for describing particular embodiments only and is not intended to be limiting of the present disclosure. As used herein, the singular forms “a,” “an” and “the” are intended to include the plural forms as well, unless the context clearly indicates otherwise. Furthermore, the use of the terms a, an, etc. does not denote a limitation of quantity, but rather denotes the presence of at least one of the referenced item. The use of the terms “first,” “second,” and the like does not imply any particular order, but they are included to identify individual elements. Moreover, the use of the terms first, second, etc. does not denote any order or importance, but rather the terms first, second, etc. are used to distinguish one element from another. It will be further understood that the terms “comprises” and/or “comprising”, or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof. Although some features may be described with respect to individual exemplary embodiments, aspects need not be limited thereto such that features from one or more exemplary embodiments may be combinable with other features from one or more exemplary embodiments.

In addition, embodiments described in the specification are wholly hardware, and may be partially software or wholly software. In the specification, “unit”, “module”, “device”, “system”, or the like represents a computer related entity such as hardware, combination of hardware and software, or software. For example, in the specification, the unit, the module, the device, the system, or the like may be an executed process, a processor, an object, an executable file, a thread of execution, a program, and/or a computer, but are not limited thereto. For example, both of an application which is being executed in the computer and a computer may correspond to the unit, the module, the device, the system, or the like in the specification.

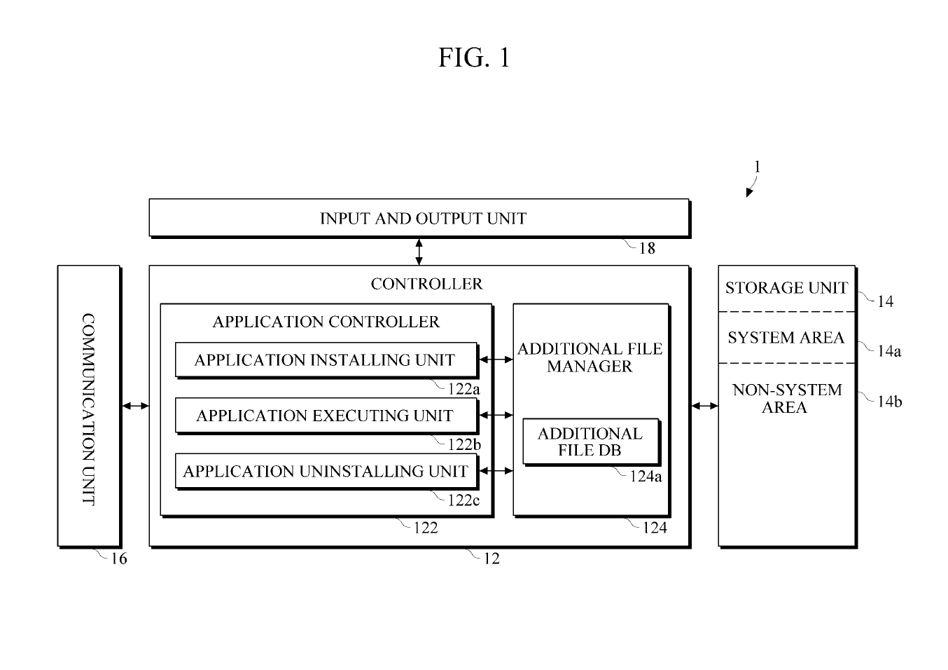

FIG. 1 illustrates a device including an application management function according to exemplary embodiments. A device 1 includes a controller 12, a storage unit 14, a communication unit 16, and an input and output unit 18. In some embodiments, the device 1 may not include a communication unit 16. The device 1 may include other modules (not shown). Different modules may be added according to the kind, function, etc. of the device 1. For example, the device 1 may further include a sensor module, such as, a gravity sensor, a proximity sensor, an acceleration sensor, a vibration generation module, a GPS module, a broadcast receiving module, or the like.

The device 1 includes an OS for controlling device operation, and instructing and controlling application programs. For example, the device 1 may be a desktop computer, a laptop computer, a tablet computer, a smart phone, a terminal, etc. The terminal may be a mobile terminal. The device 1 may be a navigation system, a set-top box, a smart television, etc. Exemplary operating systems include Microsoft WINDOWS, or Apple MAC, ANDROID, IOS, or WINDOWS MOBILE.

A variety of applications may be installed in the device 1. Some applications are installed by the manufacturing company of the device 1, some by a communication company before the device 1 is released, and some by a user. The user can install, update or uninstall applications.

The applications are installed in a system area 14a of the storage unit 14, together with the OS. The OS may allocate a part of a system area 14a to the applications in order to install the applications. All or a part of the installed applications may access the system area 14a or a non-system area 14b of the storage unit 14 to create and store data (files) required for executing the corresponding applications, or may access data (files) stored in the system area 14a or the non-system area 14b to correct, use, or delete the data (files).

A part of the system area 14a is inaccessible by a user application, and corresponds to storage that is managed by the system or OS for its own use. When an application is installed, OS allocates a part of a system area to the corresponding application, and application software is installed and stored in the allocated system area. The non-system area 14b includes a storage space that is logically or physically distinguished from the system area 14a of the internal memory. The storage space of the non-system area 14b, which is logically distinguished from the system area 14a, may correspond to a partition (for example, in the case of a PC, “D” or “E” drive except for “C” drive) that is different from a partition of the internal memory including the system area 14a. The storage space of the non-system area 14b, which is logically distinguished from the system area 14a, may correspond to an additional memory included in a device, such as, an external memory.

The controller 12 performs management, processing, and control functions of the device 1. The controller 12 may perform control and signal processing of hardware modules included in the device 1, for example, various kinds of sensor modules, an input and output module, a communication module, a storage module, etc. For example, the controller 12 may control the operation of the communication unit 16 so that the device 1 can communicate with a server or another user device to perform data communication, a voice call, a video call, etc. The controller 12 may perform processing in response to a user input signal of the input and output unit 18, and output the result of the processing of the input signal or the execution result of the corresponding application through an output module of the input and output unit 18.

The controller 12 may control all applications installed in the device 1. The controller 12 may include an application controller 122. The application controller 122 may control updating, executing, or uninstalling of applications in the device 1. The configuration of the application controller 122 is not limited. For example, the application controller 122 may include an application installing unit 122a for controlling operations of installing and updating applications. The application controller 122 may include an application executing unit 122b for controlling operation of executing installed applications. The application controller 122 may include an application uninstalling unit 122c for controlling operation of uninstalling installed applications. Updating an application may include a process of uninstalling a previously installed application and installing a new version of application. In some embodiments, both the application installing unit 122 and the application uninstalling unit 122c may participate in operation of updating an application.

The controller 10 may manage additional application files (hereinafter, simply referred to as “additional files”). The additional files include files that are stored in the non-system area 14b of the storage unit 14. The additional files correspond to files that applications access from the non-system area 14b to create, correct, use, or delete when the applications are executed. According to exemplary embodiments, the additional files may include files that are stored in the system area 14a of the storage unit 14, together with applications. The following description relates to management of additional files that are stored in the non-system area 14b. However, according to aspects of the invention, additional files that are stored in the system area 14a can also be managed in the same manner as additional files that are stored in the non-system area 14b.

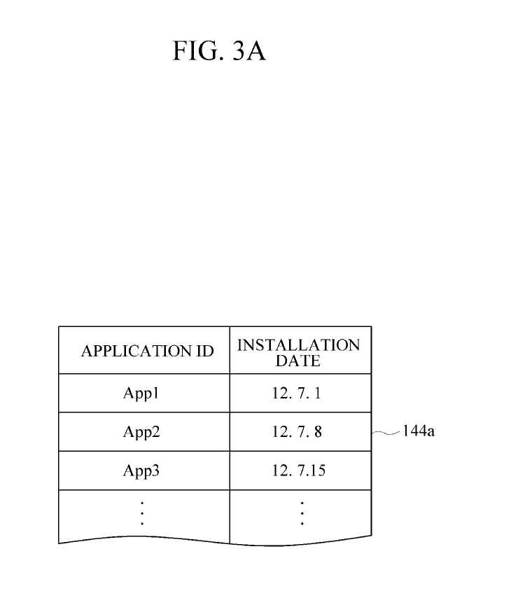

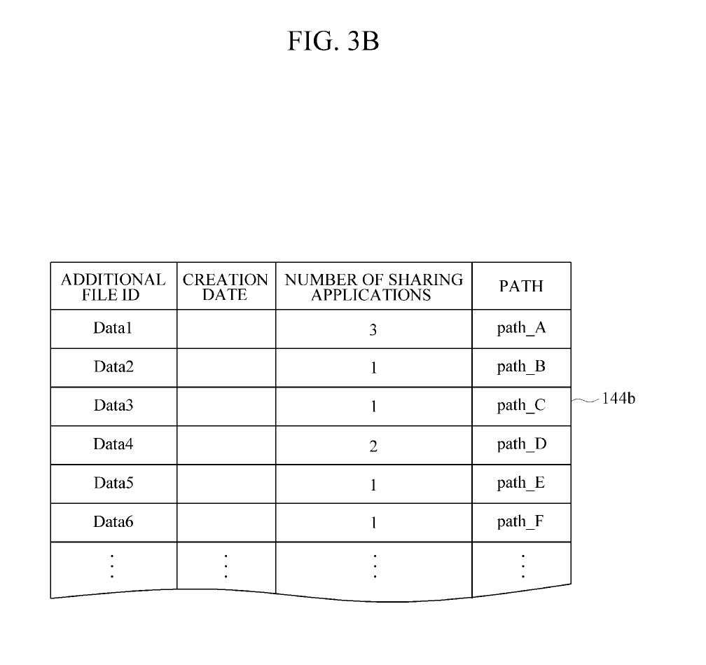

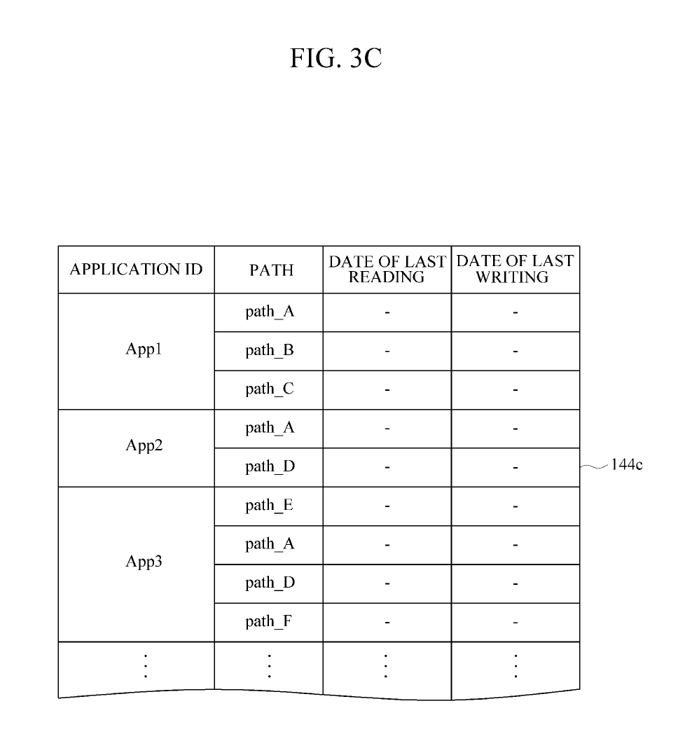

For management of additional files, the controller 12 may include an additional file manager 124. If the application executing unit 122b executes an installed application so that the application accesses the non-system area 14b to create or store one or more additional files, the additional file manager 124 may perform management of the created additional files. Here, “management of additional files” includes storing information about additional files in an additional file database 124a. The “information about additional files” or the “additional file DB 124a” is described below with reference to FIG. 3A, FIG. 3B, and FIG. 3C. In some embodiments, the additional file DB 124a is included in the additional file manager 124 as illustrated in FIG. 1. In some embodiments, the additional file DB 124a may be a separate component from the additional file manager 124.

When an application accesses the non-system area 14b additional files, the additional file manager 124 may perform management of the additional files. Here, the “management of additional files” includes updating information about the additional files in the additional file DB 124a as necessary, and deleting information about the deleted additional files from the additional file DB 124a.

When the application-uninstalling unit 122c uninstalls an installed application, the additional file manager 124 may perform management of related additional files. Here, the “management of additional files” includes executing an additional file deletion procedure for deleting the related additional files to the uninstalled application.

The additional file manager 124 may control the input and output unit 18 to perform interactions with a user for management of additional files. For example, the additional file manager 124 may output a query message or a notice message required for management of additional files through the output module, for example, a display or a touch screen, of the input and output unit 18. The additional file manager 124 may perform processing in response to a user input, for example, a user input of touching an arbitrary menu button included in a query message displayed on the display, received through the input module of the input and output unit 18, and output the result of the processing through the output module.

When an application is uninstalled, the additional file manager 124 may cause the controller 12 to signal a module, for example, a file manager, in charge of deleting files from the non-system area 14b to delete the corresponding additional files. The application uninstall or additional file deletion may be predicated by requesting a user instruction or permission. In some embodiments, the additional file manager 124 may have a file deletion function to delete additional files in the non-system area 14b.

According to an example, the additional file manager 124 may recognize creation, correction, or deletion of additional files with respect to the non-system area 14b, resulting from installation, execution, or uninstallation of applications. The additional file manager 124 can communicate with a module that is in charge of inputting and outputting additional files with respect to the non-system area 14b, that is, writing additional files in the non-system area 14b and reading additional files from the non-system area 14b.

A device, specifically, a mobile device is largely configured with a hardware layer, a platform that processes and transfers signals received through the hardware layer, and an application program layer that are configured with various application programs that are driven based on the platform. The platform may be classified into an ANDROID platform, a WINDOW MOBILE platform, and an IOS platform, etc. according to the OS of a portable electronic device. The platforms have basically the same functions although they have slightly different structures. The ANDROID platform is configured with a Linux kernel layer, a library layer, and a framework layer; the WINDOWS MOBILE platform is configured with a widow core layer and an interface layer; and the IOS platform is configured with a core OS layer, a core service layer, a media layer, and a cocoa touch layer. The individual layers are also called blocks, and the framework layer of the ANDROID platform or the corresponding layers of other platforms may be defined as software blocks.

When files including additional files are input or output in the device 1, generally, processing is performed through a software block. In some embodiments, the additional file manager 124 may be implemented in the form of a manager of additional files in a software block. When there is an input/output event of an additional file requested by a specific application, a module in a software block, in charge of inputting or outputting additional files, performs substantial processing related to the input/output of the additional file. The software block may notify the additional file manager 124 of information, for example, identification information (ID) of the application, the path of the additional file, read/write information, etc., about the additional file. The additional file manager 124 may perform management of the additional file, using the information about the additional file.

According to an aspect, the additional file manager 124 may manage additional files using the additional file DB 124a. The additional file DB 124a may be either included in the additional file manager 124 or stored in the non-system area 14b of the storage unit 14. The additional file DB 124a is used by the additional file manager 124 to manage additional files when applications are installed, executed, or uninstalled. The additional file DB 124a stores information about additional files and also corrects and deletes the information about the additional files.

The information about the additional files includes all information required for management of additional files that are generated, received, or referred to in relation to the corresponding application. The information about the additional files includes a minimum of information required to manage or delete additional files that are no longer needed when a user uninstalls the corresponding application. The information about the additional files may include “application identification information,” “additional files identification information,” and “information about the storing paths of additional files.” The application identification information is information for identifying the application that has created the additional files. The additional files identification information is information for identifying the additional files. The information about the storing path of additional files is information indicating locations at which the additional files have been stored. According to an example, information about the storing paths of additional files can be used as additional files identification information.

The information about the additional files may include sharing information of the additional files. The sharing information is information indicating whether the additional files are used or referred to in common by a plurality of applications. The sharing information may be represented in various formats. For example, the sharing information may indicate whether the corresponding additional file is shared (in this case, the sharing information may be represented simply by “Yes” or “No”). The sharing information may indicate the number of applications sharing the corresponding additional file represented by an integer; for example, if the value of the sharing information is “1”, it means that the corresponding additional file is not shared by a plurality of applications, and if the value of the sharing information is “2”, it means that the corresponding additional file is shared by two applications.

The information about the additional files may include information related to the additional files and the application that created the additional files. For example, the information about the additional files may include “installation date information” indicating a date (and a time) when the application was installed, “file date information” indicating a date (and a time) when the additional files were created, “information about the last dates of reading” indicating dates (and times) when the additional files were last used, and/or “information about the last dates of writing” indicating dates (and times) when data was last written in the additional files.

The additional file DB 124a may be configured in the form of a single table or a plurality of tables. The format of each table or items included in the format can also be configured in various manners.

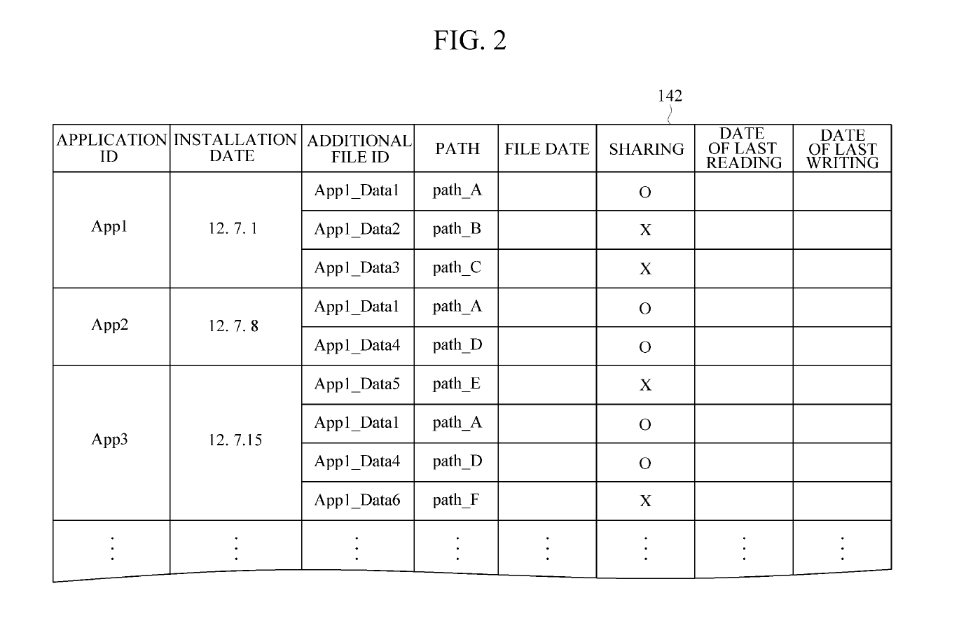

FIG. 2 illustrates an additional file DB configured in the form of a table according to exemplary embodiments. In the additional file DB table, values App1, App2, App3, etc. for an “application ID” column are the unique names of applications. Corresponding to the application identification, values App1_Data1, App1_Data2, App1_Data3, App2_Data1, App2_Data4, etc. for “additional file ID” column are the names of additional files that are stored in a non-system area. Corresponding to additional files identification values path_A, path_B, path_C, path_D, etc. for a “path” column are locations at which the corresponding additional files are stored in the non-system area. Values 0 and X for a “sharing” column correspond to sharing information, an “installation date” column includes dates at which the corresponding applications have been installed, a “file date” column include dates at which the corresponding additional files have been created. The additional file DB table may include a “last date of reading” column including dates at which the corresponding additional files have been last read, and a “last date of writing” column including dates at which data has been last written to the corresponding additional files.

Additional files are listed in unit of an application. For example, the application App1 uses three additional files App1_Data1, App1_Data2, and App1_Date3. In the example of FIG. 2, the additional files App1_Data2, and App1_Date3 are used only by the application App1 and are not shared. In some embodiments, applications other than App1 are disallowed access to the additional files App1_Data2, and App1_Date3.

The additional file DB table includes information indicating whether or not an additional file is shared with other applications, for example, by “O” and “X” in FIG. 2, by binary numerals “0” and “1” (not shown), or the like. In the additional file DB table, additional files having the same storing path information among additional files whose sharing information is “O” are substantially the same additional file. For example, additional files App1_Data1, App2_Data1, and App3_Data1 having the same storing path information path_A are the same additional file, and additional files App2_Data4 and App3_Data4 having the same storing path path_D are the same additional file. That is, the names of additional files are different according to applications; however, additional files having the same storing path are substantially the same additional file.

FIG. 3A illustrates an additional file DB including an application table according to exemplary embodiments. FIG. 3B illustrates an additional file DB including an additional file table according to exemplary embodiments. FIG. 3C illustrates an additional file DB including an application management table according to exemplary embodiments. FIG. 3A, FIG. 3B, and FIG. 3C illustrate an additional file DB, wherein the additional file DB includes a plurality of tables, namely, an application table 144a (FIG. 3A), an additional file table 144b (FIG. 3B), and an application management table 144c (FIG. 3C). In some embodiments, the additional file DB may be configured with a different number of tables, for example, two tables, four tables or more.

The application table 144a of FIG. 3A can manage information about applications. The application table 144a can include an “application ID” column for writing the IDs of applications installed in a system area (see 14a of FIG. 1), and an “installation date” column for writing dates at which the corresponding applications have been installed. When an application is installed or uninstalled from the device 1 (see FIG. 1), data about the application may be added to or deleted from the “application ID” column.

The additional file table 144b of FIG. 3B can manage information about additional files that are stored in a non-system area (see 14b of FIG. 1). The additional file table 144b can include an “additional file ID” column for writing information about the IDs of additional files that are stored in the non-system area, a “file date” column for writing dates at which the corresponding additional files have been created, a “number-of-sharing applications” column for writing the number of applications sharing the corresponding additional files, and a “path” column for writing locations at which the corresponding additional files have been stored. When an additional file is created, corrected, or deleted by execution of an application, data may be written on, corrected in, or deleted from the individual columns of the additional file table 144b. When an additional file stored in the non-system area is deleted by uninstallation of an application, data written on the individual columns of the additional file table 144b may be deleted.

The application management table 144c of FIG. 3C includes relationship information between arbitrary applications and the related additional files. The application management table 144c includes an “application ID” column for identifying applications, and a “path” column for writing locations at which the corresponding additional files have been stored. In some embodiments, other information (for example, the identification information of additional files) for indicating additional files can be used instead of the “path” column or added to the application management table 144c together with the “path”. The application management table 144c may include a “last date of reading” column for writing dates at which accesses to the additional files have been lastly made, and a “last date of writing” column for writing dates at which data has been lastly written in the additional files. When data is written to the application table 144a of FIG. 3A and/or the additional file table 144b of FIG. 3B, the application management table 144c of FIG. 3C may change accordingly.

The sharing information column relates to the numbers of applications sharing the corresponding additional files on the additional file table 144b. In the additional file table 144b, an additional file having sharing information “1” represents that the additional file is accessed by only one application. An additional file having sharing information “2” or more represents that the additional file is accessed by a plurality of applications. For example, in the additional file table 144b of FIG. 3B, the additional file Data1 having the storing path information path_A is shared with three applications App1, App2, and App3 in the application management table 144c, and the additional file Data4 having the storing path information path_D is shared with two applications App2 and App3.

Referring again to FIG. 1, the storage unit 14 may store application programs, data (file), etc. needed for the management and operation of the device 1. The storage unit 14 may store application programs for the processing and control of the controller 10, for example, OS programs, a plurality of functional module programs, application programs, etc. The storage unit 14 may store additional files that are created or received when applications are installed or executed, as well as data or information, such as, mails, text, images, video, document, music, phone numbers, call logs, messages, or the like. The storage unit 14 may be an internal memory, such as, Random Access Memory (RAM), an external flash memory, a magnetic disk memory, a Read Only Memory (ROM), or the like.

The storage unit 14, for example, an internal memory may be partitioned into the system area 14a and the non-system area 14b. The system area 14a and the non-system area 14b are storage spaces corresponding to different partitions. If the storage unit 14 of the device 1 includes an external memory, the external memory may be included in the non-system area 16b. A user or an authorized application may access the non-system area 14b to read/write data in the non-system area 14b or to access, correct or delete data written in the non-system area 14b.

The communication unit 16 can receive and transmit data, signals, etc. through a network, for example, a wired network, a wireless network, a combination thereof, or the like. The communication unit 16 may perform communication according to one or more communication protocols, and the kinds or numbers of the communication protocols are not limited. The device 1 may receive an application installation file through the communication unit 16 to install the application installation file in the system area 14a of the storage unit 14.

Device 1 may receive additional files through the communication unit 16, when an application is installed or executed, to store the additional files in the non-system area 14b of the storage unit 14. In some embodiments, a user may copy or move additional files stored in the system area 14a to the non-system area 16b.

The input and output unit 18 can include an input module for inputting user data or inputs, commands, request signals, etc. to the device 1. The input and output unit 18 can include an output module for outputting data, information, signals, etc. processed by the device 1. The input module may include, for example, a camera for inputting image/video signals, a microphone for inputting voice or sound, a keypad, a dome switch, a button, a jog wheel, a touch pad, and the like for allowing a user to input data or commands to the device 1. The output module may include, for example, a display for outputting image/video signals, an audio output device for outputting audio signals, a haptic device, or the like.

The device 1 may include a touch screen (not shown) as an input and output unit 18. The touch screen provides for interactions between a user and the device 1, and can function as a touch pad that is a component of the input module and as a display that is a component of the output module. The touch screen can include a stacked structure where a touch pad is combined with a display. In some embodiments, the touch screen can include a touch pad integrated with a display.

The user may input a command or information to the device 1 by touching the touch screen with his or her finger, a stylus pen, etc. The device 1 may output text, an image, and/or video, etc. for the user through a touch screen. For example, the controller 12 of the device 1 may output a query, a notice message, and the like needed for managing additional files through the touch screen. The user may input a response, a command, and the like to the controller 12 of the device 1 by touching a query or a response button/menu included in the query and displayed on the touch screen.

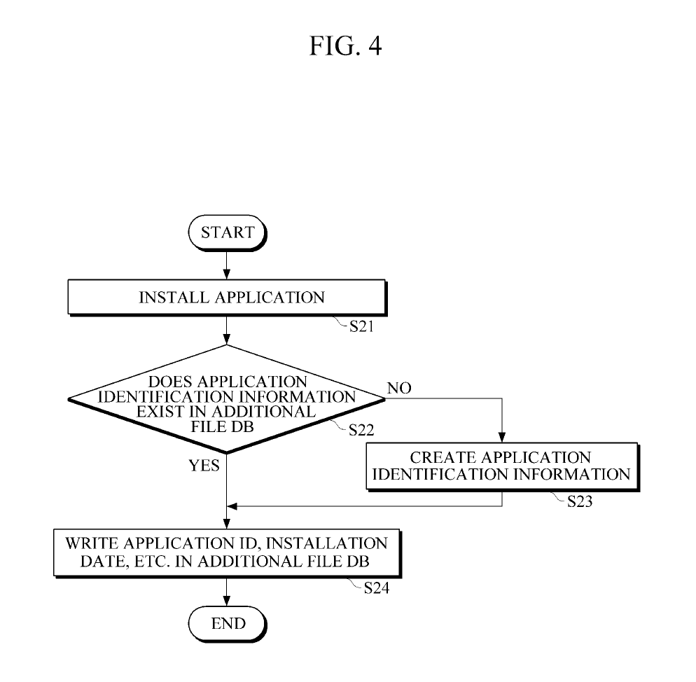

FIG. 4 illustrates an application management method according to exemplary embodiments. The application management method may be performed by the device 1 having the application management function, as described above with reference to FIG. 1, using the additional file DB as described above with reference to FIG. 2 or FIGS. 3A through 3C. Accordingly, the description of FIG. 1 through FIG. 3C may be applied to the application management method.

The application management method illustrated in the flowchart of FIG. 4 corresponds to the case where a new application is installed in the storage unit 14 of the device 1 (see FIG. 1).

Referring to FIGS. 1 and 4, a new application can be installed in the device 1 (S21). For example, the kind of application may be arbitrarily installed in the device 1 by a user according to his or her need or taste. Operation S21 of installing the new application may be applied to the case where a manufacturing company or a communication company installs an application in the device 1. The application may be installed in the storage unit 14. In some embodiments, the application may be installed in the system area 14a of an internal memory.

When the application is installed, the additional file manager 124 determines whether the identification information of the application exists in the additional file DB 124a (S22). Generally, the identification information of an application that is newly installed does not exist in the additional file DB 124a. However, if an application is installed after it has been previously installed and uninstalled, or if an installed application is updated, the identification information of the application may exist in the additional file DB 124a. Operation S22 may be performed by checking whether the identification information of the application exists in the additional file DB table, for example, the additional file DB table 142 of FIG. 2 or the application table 144a of FIG. 3A.

When the identification information of the application does not exist in the additional file DB 124a (the “NO” branch of operation S22), an identification information item of the application to be installed is created (operation S23) in the additional file DB 124a. For the additional file DB table of FIG. 2, operation S23 may add a row for the identification information of the application to the additional file DB table 142, or may write the identification information of the application to an empty row. For the additional file DB 124a illustrated by tables 144a, 144b, and 144c of FIG. 3A, FIG. 3B, and FIG. 3C, operation S23 may add a row for the identification information of the application to the application table 144a of FIG. 3A and the application management table 144c of FIG. 3C. In some embodiments, operation S23 may write the identification information of the application to empty rows application table 144a and/or application management table 144c. When the additional file DB 124a uses a separate table to each application, in operation S23, a table for the installed application may be created.

When the identification information of the application exists in the additional file DB 124a (“YES” branch of operation S22) or after operation S23, information related to the identification information of the application is written in the additional file DB 124a (S24). In operation S24, information related to the application, for example, an installation date, or the like, may be written on the same row as the identification information of the application in the additional file DB table 142 of FIG. 2 or the additional file table 144b of FIG. 3B. According to an example, in operation S24, the ID of the application, an installation date of the application, or like may be written in a separate table for the application.

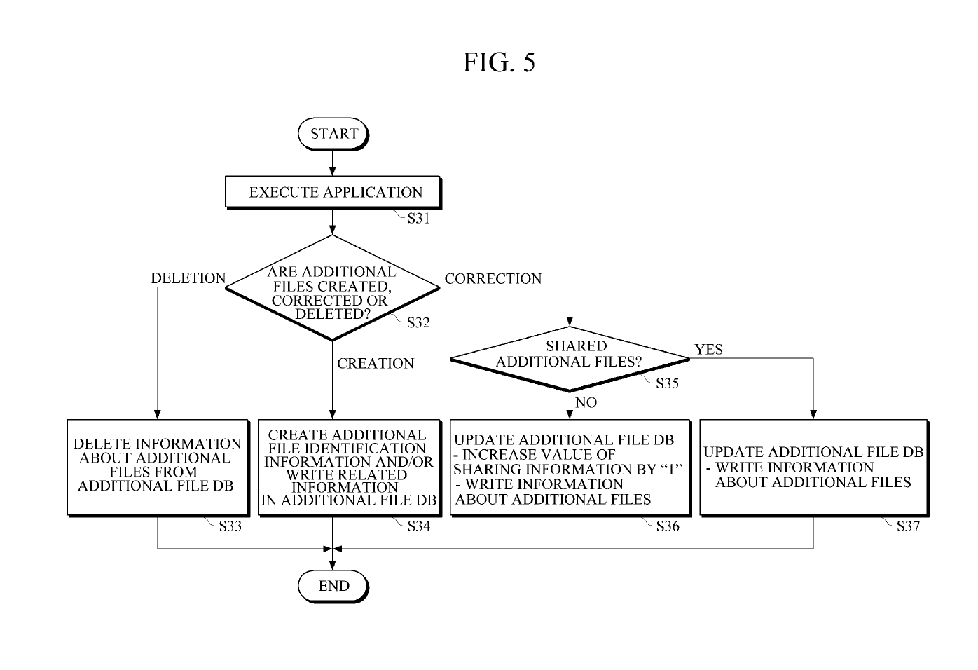

FIG. 5 illustrates an application management method according to exemplary embodiments. The application management method may correspond to the case where one or more additional files are created, corrected or deleted during application execution, install, uninstall, or reinstall.

Referring to FIGS. 1 and 5, an application is executed in the device 1 (S31). Operation S31 of executing the application may be an application being executed in the foreground or background.

The additional file manager 124 of the device 1 can determine whether creation, correction, or deletion of one or more additional files occurs in the non-system area 14b of the storage unit 14 (S32). A creation, correction, or deletion of one or more additional files generally occurs while reading/writing the additional files in the non-system area 14b of the storage unit 14. The additional file manager 124 may determine whether creation, correction, or deletion of additional files occurs, based on information, for example, file paths, dates of reading/writing, related to reading/writing with respect to additional files.

If it is determined in operation S32 that an additional file has been deleted, the additional file manager 124 deletes information about the additional file deleted from the additional file DB 124a (S33). For example, if the exemplary additional file DB table 142 of FIG. 2 is used to manage additional files, in operation S33, all data corresponding to the deleted additional file may be deleted from the additional file DB table 142. If the exemplary tables 144a, 144b, and 144c of FIG. 3A, FIG. 3B, and FIG. 3C are used to manage additional files, in operation S33, all data corresponding to the deleted additional file may be deleted from the additional file table 144b and the application management table 144c.

If it is determined in operation S32 that an additional file has been created, the additional file manger 124 writes information about the corresponding additional file in the additional file DB 124a (S34). Information about an additional file created by the application executed in operation S31 are written on the row of the corresponding application ID of the additional file DB table 142 of FIG. 2. In some embodiments, a new row is created in the additional file table 144b of FIG. 3b including information, such as, an additional file ID, a date at which the additional file has been created, the number of applications sharing the additional file, a storing path, and the like, Moreover, the storing path, a data at which the additional file has been lastly read, a date at which data has been lastly written in the additional file, etc. are written in the application management table 144c of FIG. 3C.

Also, if it is determined in operation S32 that an additional file has been corrected, the additional file manager 124 updates information about the corresponding additional file in the additional file DB 124a (S35 through S37). “Correction of an additional file” is not limited to the case where the content of an additional file has changed, and includes the case where information about an additional file has changed, such as, sharing information, a data at which the additional file has been lastly read, a date at which data has been lastly written in the additional file. Accordingly, the “correction of an additional file” includes accessing an additional file, for example, an additional file created by the application executed in operation S31 or by another application) stored in the non-system area 14b to read the additional file when an application is executed (S31).

The additional file may be an additional file shared or not shared with the application. The additional file not shared with the application parameter may indicate an additional file that the application has not accessed until now. Accordingly, if it is determined in operation S32 that an additional file needs to be corrected, it is determined whether the corresponding additional file is shared with the executed application (S35). The update result of the additional file DB 124a may depend on the result of the determination (S36 and S37).

If it is determined in operation S35 that the corresponding additional file is not shared with the application, the additional file DB 124a is updated to increment the corresponding sharing information in the additional file DB 124a by “1,” and write the remaining information about the additional file in the additional file DB 124a. If it is determined in operation S35 that the corresponding additional file is shared with the application, the additional file DB 124a is updated in a manner to maintain the value of the corresponding sharing information in the additional file DB 124a and write the remaining information about the additional file in the additional file DB 124a (S37). The “remaining information about the additional file” may include “ID of the additional file”, “storing path”, “date at which the additional file has been lastly read”, “data at which data has been lastly written in the additional file”, etc.

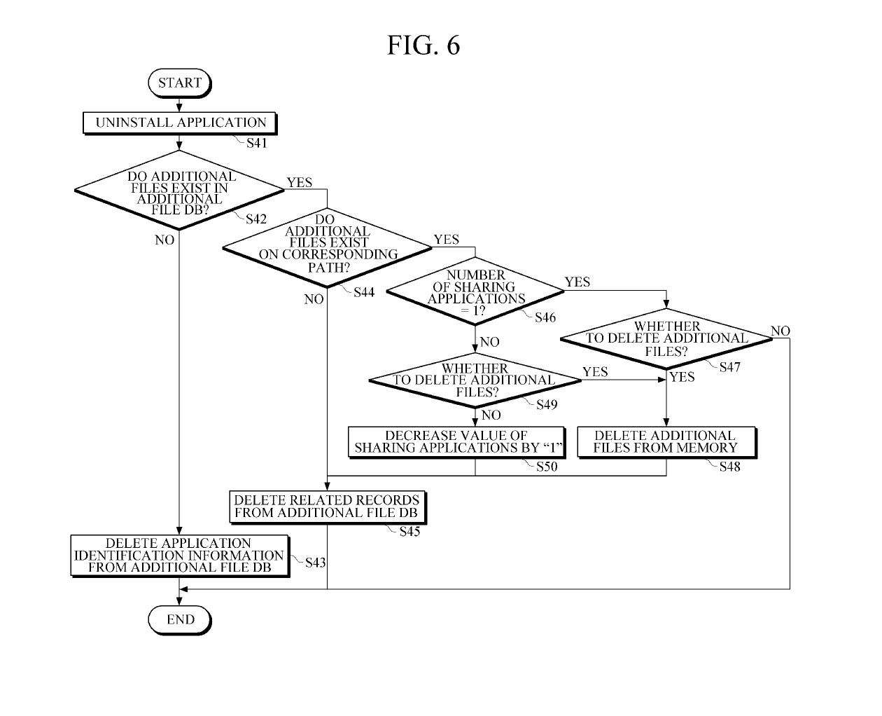

FIG. 6 an application management method according to exemplary embodiments. The application management method illustrated in the flowchart of FIG. 6 corresponds to the case where a device uninstalls an application. By deleting additional files stored in the non-system area when an installed application is uninstalled, it is possible to efficiently manage a memory.

Referring to FIG. 1 and FIG. 6, an application installed in the device 1 is uninstalled (S41).

After the application is uninstalled, it is determined whether additional file items related to the uninstalled application exist in the additional file DB 124a (S42). Related files are additional files that the uninstalled application has created or accessed in the non-system area 14b. For this, it may be determined whether the identification information (IDs and/or storing paths) of additional files exist on rows including the ID of the uninstalled application in the additional file DB table 142 of FIG. 2 or in the application management table 144c of FIG. 3C.

If no additional file related to the uninstalled application exists in the additional file DB 124a (“NO” branch of S42), all records related to the application are deleted from the additional file DB 124a (S43). The deleted records include the application identification information of the uninstalled application (see operations S23 and S24 of FIG. 3). The deleted records may include a date at which the uninstalled application was installed (see operation S24 of FIG. 3). In operation S43, all records related to the application may be deleted from the additional file DB table 142 of FIG. 2 or from the application table 144a of FIG. 3A and the application management table 144c of FIG. 3C.

If additional files related to the uninstalled application exist in the additional file DB 124a (“YES” branch of S42), it is determined whether the additional files exist in the non-system area 14b (S44). There may be one or more additional files and operation S44 may be performed for each additional file. File paths of the additional files may be recognized, for example, from the additional file DB table 142 of FIG. 2 or the application management table 144c of FIG. 3C. If “additional file IDs” are used as the identification information of the additional files in the application management table of FIG. 3C, paths at which the additional files are stored can be recognized by using the additional file table 144b of FIG. 3B together with the application management table of FIG. 3C.

If it is determined in operation S44 that no additional file exists on the corresponding path (“NO” branch of S44), all of the related records are deleted from the additional file DB 124a (S45). In some embodiments, the deleted records include the application identification information of the uninstalled application and the identification information of the additional files. The related records may include a date at which the uninstalled application has been installed, a date at which the additional files have been created, dates at which the additional files have been lastly read, dates at which data has been lastly written in the additional files, etc. In operation S45, the above-described records may be deleted from the additional file DB table of FIG. 2 or the tables 144a, 144b, and 144c of FIG. 3A, FIG. 3B, and FIG. 3C.

If one or more additional files exist on the corresponding path in operation S44 (“YES” branch), it is determined whether the additional files are shared with other applications (S46). That is, in operation S46, it may be determined whether the additional files that are deleted are shared files that can be used (accessed) by other applications except for the uninstalled application. The determination on whether the additional files are shared files may be performed based on the sharing information (“O” or “X” information indicating sharing or non-sharing) of the additional file DB table 142 of FIG. 2 or information about the number of sharing applications of the additional file table 144b of FIG. 3B. In the latter case, if the number of sharing applications is “1”, it means that the corresponding additional file is not shared with others applications, and if the number of shared application is “2” or more, it means that the corresponding additional file is shared with other applications.

If it is determined in operation S46 that the additional files are used by only the uninstalled application, a procedure of deleting the additional files begins. In this case, the additional file manager 124 may delete the additional files, without receiving permission from a user or after receiving permission from the user. In the former case, the additional file manager 124 may control an application having a file deletion function, for example, a file manager to directly perform a process of deleting the corresponding additional files. Meanwhile, in the later case, the additional file manager 124 may perform a procedure for getting permission from the user.

The flowchart illustrated in FIG. 6 corresponds to the latter case. If it is determined in operation S46 that the additional files are used by only the uninstalled application (“YES” branch), a procedure of deleting the additional files begins. The additional file manager 124 may delete the additional files with or without receiving permission from a user.

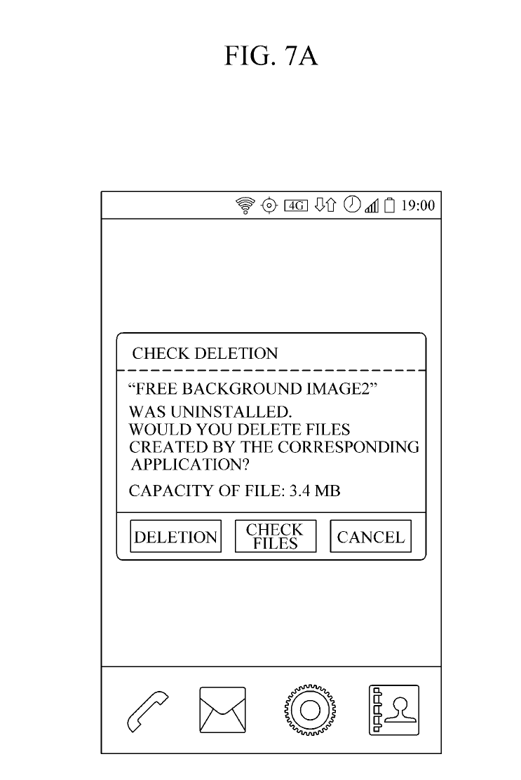

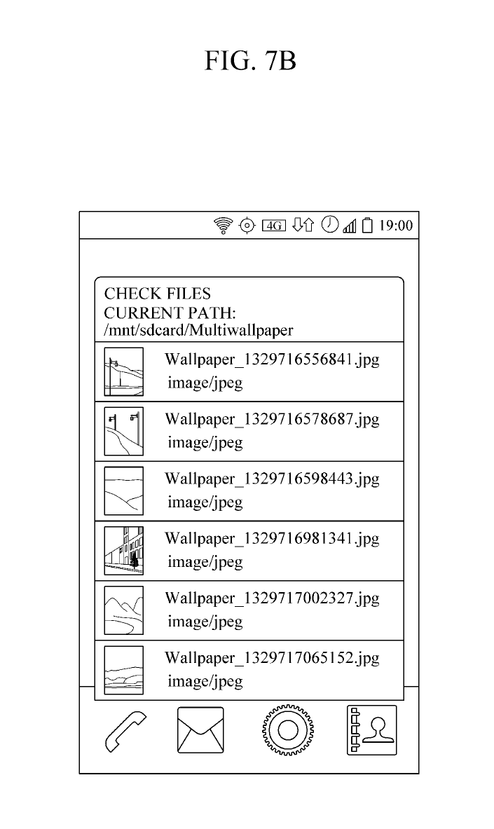

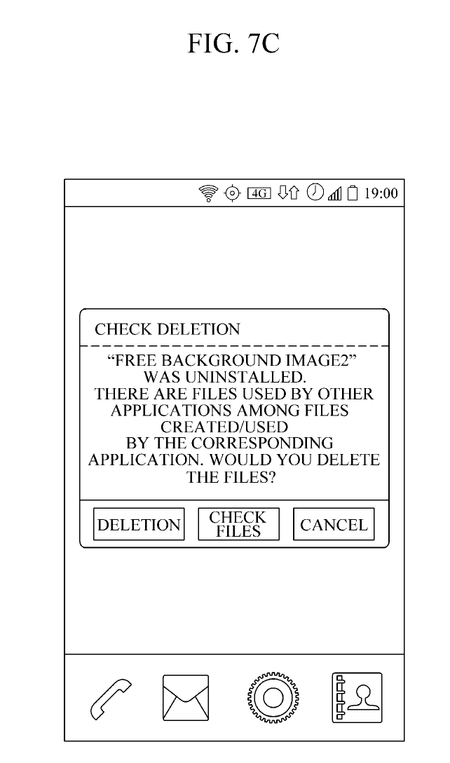

When the additional file manager 124 requests user permission, the additional file manager 124 outputs inquires whether to delete the additional files, through the output module of the input and output unit 18 (S47). For example, if the device 1 includes a touch screen as the input and output unit 18, the query may be displayed on the touch screen, as shown in FIG. 7A. FIG. 7A illustrates a screen displayed on a touch screen when a process of deleting additional files proceeds according to exemplary embodiments. In this example, when an application “free background image” is uninstalled, a query for inquiring whether to delete additional files created by the uninstalled application may be displayed on the touch screen. Exemplary commands, a “deletion” menu, a “check files” menu, and a “cancel” menu for allowing the user to input a response are displayed together with the query. According to an example, a list of additional files to be deleted may be displayed together with the query.

If a deletion request is received from the user, for example, if the user's touch on the “deletion” menu bar is sensed in the example of FIG. 7A, the additional file manager 124 controls the deletion of the corresponding additional files (S48). If no deletion request is input by the user, for example, if the user's touch on the “cancel” menu bar is sensed in the example of FIG. 7A, the additional files are not deleted. If it is determined in operation S47 that a request for checking the additional files is received from the user, that is, if the user's touch on the “file check” menu bar is sensed in the example of FIG. 7A, the additional file manager 124 may display a list of additional files to be deleted on the touch screen.

FIG. 7B illustrates a screen displayed on a touch screen when a process of deleting additional files proceeds according to exemplary embodiments. FIG. 7B corresponds to the case where the user has touched the “file check” menu bar on the screen of FIG. 7A. The user may determine whether to delete the additional files after reviewing information displayed in FIG. 7B. In some embodiments, the user can selectively delete additional files from the list of additional files. By allowing the user to select each additional file on the list of additional files, for example, by adding a check box to each item of the list of additional files, the user may selectively delete some of the additional files.

If it is determined in operation S46 that the additional files are used by applications other than the uninstalled application (“NO” branch of S46), a procedure of deleting the additional files begins. In some embodiments, the procedure of deleting the additional files may get permission from the user per operation S49. Details for the procedure of deleting the additional files may be different from operations S47 and S48 described above

If it is determined in operation S46 that the additional files are files (hereinafter, referred to as “shared additional application files” or “shared additional files”) being used by applications other than the uninstalled application, like operation S47, the additional file manager 124 outputs a query for inquiring of whether to delete the shared additional files, through the output module of the input and output unit 18 (S49). The query may indicate that the additional files are shared with other applications. FIG. 7C illustrates a screen displayed on a touch screen when a process of deleting additional files proceeds according to exemplary embodiments. If an application “free background image” is uninstalled, a query for inquiring of whether to delete additional files created by the uninstalled application although the additional files are used by other applications may be displayed on a touch screen. Like FIG. 7A, commands including a “deletion” menu, a “check files” menu, and a “cancel” menu for allowing a user to input a response may be displayed together with the query. In some embodiments, a list of additional files to be deleted may be displayed together with the query.

If a deletion request is input by the user to delete the shared additional files, for example, if the user's touch on the “deletion” menu bar is sensed in the example of FIG. 7C, the additional file manager 124 controls the application having the file deletion function of the device 1, for example, the file manager to delete the shared additional files (S48). If no deletion request is input by the user to delete the shared additional files, for example, if the user's touch on the “cancel” menu bar is sensed in the example of FIG. 7A, the shared additional files are not deleted. Although the shared additional files are not deleted, information related to the additional files may be corrected in the additional file DB 124a. For example, it is possible to change the corresponding sharing information from “O” to “X” in the additional file DB table of FIG. 2 or to decrease the values of “number of sharing applications” by “1” in the additional file DB 144b of FIG. 3B (S50).

If a request for checking the shared additional files is input by the user in operation S49, that is, if the user's touch on the “file check” menu bar is sensed in the example of FIG. 7A, like operation S47, the additional file manager 124 may display a list of additional files to be deleted on a touch screen (see FIG. 7B).

Therefore, according to the examples as described above, by deleting additional application files stored in a non-system area when an application is uninstalled, it is possible to manage a memory.

A number of examples have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A terminal for managing applications, the terminal comprising:
an application controller configured to install, execute and uninstall an application on the computer;
a non-system area configured to store an additional file associated with the application; and
an additional file manager configured to manage an additional file database that stores the association of the application to the additional file,
wherein the application controller communicates with the additional file manager when the non-system area is accessed.

2. The terminal of claim 1, wherein the application controller communicates with the additional file manager when the additional file in the non-system area is accessed.

3. The terminal of claim 1, wherein the application controller stores the additional file in the non-system area during application installation.

4. The terminal of claim 1, wherein the application controller executes the application and communicates an access to the additional file by the application to the additional file manager.

5. The terminal of claim 4, wherein the application requests a file operation on the additional file and the additional file manager updates the association of the additional file to the application based on the requested file operation.

6. The terminal of claim 1, wherein the additional file manager associates the additional file with a plurality of applications by storing a shared indication corresponding to the additional file in the additional file database.

7. The terminal of claim 1, wherein the application controller is configured to request a deletion of the additional file during application uninstall, and the additional file manager selectively deletes the additional file and updates the respective association of the additional file to the application.

8. The terminal of claim 7, further comprising a display configured to display an additional file delete confirmation.

9. The terminal of claim 1, further comprising a communication unit configured to receive the additional file.

10. A method for managing applications on a terminal, the method comprising:
installing, executing and uninstalling an application on the computer;
providing a non-system area for storing an additional file associated with the application; and
managing an additional file database that stores the association of the application to the additional file, based on a communication indicating an access to the non-system area.

11. The method of claim 10, wherein the managing further comprises receiving a communication indicating an access to the additional file in the non-system area.

12. The method of claim 10, further comprising storing the additional file in the non-system area during application installation.

13. The method of claim 10, further comprising executing the application, and the managing further comprises a communication indicating an access to the additional file by the application.

14. The method of claim 13, wherein the application operates on the additional file and the managing further comprises updating the association of the additional file to the application based on the application operation.

15. The method of claim 10, wherein the managing further comprises associating the additional file with a plurality of applications by storing a shared indication corresponding to the additional file in the additional file database.

16. The method of claim 10, further comprising receiving a deletion request of the additional file in the non-system area during application uninstall, and the managing further comprises selectively deleting the additional file and updating the respective association of the additional file to the application.

17. The method of claim 16, further comprising displaying an additional file delete confirmation interface.

18. The method of claim 10, further comprising receiving the additional file over a communications interface.

19. A non-transitory readable storage that, when executed by a terminal comprising a display and one or more processors, causes the one or more processors to perform operations to manage applications of the terminal, the operations comprising:
installing, executing and uninstalling an application on the computer;
providing a non-system area for storing an additional file associated with the application; and
managing an additional file database that stores the association of the application to the additional file, based on a communication indicating an access to the non-system area.
